(19) United States
(12) Patent Application Publication
(10) Pub. No.: US 2026/0266683 A1
(43) Pub. Date: Sep. 10, 2026

(54) METHOD FOR INSPECTING A METAL CONCRETE-PRESTRESSING ELEMENT OF A PIPELINE, AND INSPECTION DEVICE

(71) Applicant: ROSENXT HOLDING AG, Stans (CH)

(72) Inventors: Andrey Danilov, Lingen (DE); Patrik Rosen, Meppen (DE); Sergio Plascencia, San Luis Obispo, CA (US)

(21) Appl. No.: 19/165,426

(22) PCT Filed: Mar. 15, 2024
(86) PCT No.: PCT/EP2024/057059

§ 371 Date: Sep. 15, 2025

(30) Foreign Application Priority Data
Mar. 15, 2023 (BE) BE2023/5189

(51) Int. Cl. G01M 5/00

(52) U.S. Cl. CPC G01M 5/0091

(57) ABSTRACT

A method is provided for inspecting a metallic concrete tensioning element of a water-carrying pipeline. A first alternating magnetic field is generated by at least one first excitation unit of an inspection device. A second alternating magnetic field is generated by at least one second excitation unit spaced apart from the first excitation unit. The first and second magnetic fields having opposite directions. During a movement of the inspection device along the concrete tensioning element, at least at one position between the first and the second excitation units via at least one magnetic field sensor of the inspection device, measurement data are recorded based on the resulting magnetic field. The measurement data are evaluated with regard to the magnitude and/or phase of the resulting magnetic field.

### CROSS REFERENCE

This application claims priority to PCT Application No. PCT/EP2024/057059, filed Mar. 15, 2024, which itself claims priority to Belgian Patent Application No. BE2023/5189, filed Mar. 15, 2023, the entireties of both of which are hereby incorporated by reference.

### FIELD OF THE INVENTION

The present invention relates to a method for inspecting a metallic concrete tensioning element, for example, a concrete tensioning wire, which is spirally embedded in a water-carrying pipeline and thus in the concrete thereof. Furthermore, the invention relates to an inspection device with which such a method can be carried out.

### BACKGROUND OF THE INVENTION

Concrete pipelines with a cylindrical metal layer or metal cylinder coated with concrete on the inside and outside are often used to transport water. On the outside, the concrete is reinforced by one or a plurality of concrete tensioning elements designed as wire or wire strands. Such concrete tensioning elements absorb the tensile stresses acting in the concrete and significantly increase the strength of the pipeline. Over time, however, the concrete tensioning elements can break, for example, due to corrosion, which leads to an increased risk of pipeline failure.

Due to the complex and inhomogeneous structure of the pipeline wall, conventional NDT methods based on ultrasonic or magnetic flux leakage measurements are not accurate enough. This applies in particular to inspection devices moving within the pipeline. It is also often not possible to inspect the concrete tensioning elements from outside the pipeline with reasonable effort as the pipelines are buried underground.

In U.S. Pat. No. 6,127,823, so-called ‘remote field eddy current’ methods are used to try to find defects, in particular places of fracture in cord-shaped concrete tensioning elements, i.e., those designed as concrete tensioning wires, for example. However, these measurements are only of low accuracy. In addition, the distance of two to three pipe diameters between the excitation unit and the sensor means that the device's ability to pass through pipelines is very limited.

It is also known from EP 2 458 376 A2 to use two sensors close to the wall to measure a resulting magnetic field that varies due to a defect. This type of measurement is also very susceptible to interference. In addition, due to the arrangement of the sensors close to the wall in frequently used pipes with butterfly valves, it is not possible to use an associated inspection device.

### BRIEF SUMMARY OF THE INVENTION

The object of the present invention is to increase the accuracy of tests on the integrity of concrete tensioning elements and to provide a corresponding device for this purpose.

In a method according to the invention for inspecting a metallic concrete tensioning element of in particular a water-carrying pipeline, a first alternating magnetic field is generated by at least one first excitation unit of an inspection device, which excitation unit preferably comprises a first excitation coil. Furthermore, a second alternating magnetic field is generated by at least one second excitation unit of the inspection device, which is spaced apart from the first excitation unit and preferably comprises a second excitation coil, wherein the first and second magnetic fields having opposite directions. Furthermore, during a movement of the inspection device along the concrete tensioning element, in particular through the pipeline, at least at one position between the first and the second excitation units via at least one magnetic field sensor of the inspection device to record measurement data based on the resulting magnetic field, which measurement data are evaluated with regard to the magnitude and/or phase of the resulting magnetic field. This data results in a characteristic signal when the inspection device moves along the concrete tensioning element in the event of a defect, which is used to conclude that a defect is present. The excitation units are spaced apart from each other in the longitudinal direction of the inspection device.

Concrete tensioning elements are cord-shaped concrete tensioning elements in the form of wire or strands consisting of several wires. The two opposing alternating fields are opposite in such a way that they cancel each other out, at least in part. The resulting magnetic field is formed by the superposition of the direct alternating fields acting directly from the excitation units in the area of the magnetic field sensor and the fields induced by metallic parts of the pipeline. The latter arise in particular due to interactions in the metal cylinder, if present, and in the concrete tensioning element.

The invention is initially based on the finding that currents are generated in the circumferential direction in the concrete tensioning element and thus in turn generates an alternating magnetic field. Although it is difficult to generate significant currents in the actually non-closed conductor of a spirally wound concrete tensioning element, it was found in the context of the invention that the conductivity between spirally wound concrete tensioning elements and also existing, axially laid concrete tensioning elements or metal cylinders is high enough to electrically connect the parts of the spirally wound wire. This connection makes it possible to induce current even in spirally wound concrete tensioning elements. In the case of non-spirally wound, in particular round and closed concrete tensioning elements that span a plane perpendicular to the pipeline axis, the induction is large enough anyway.

Correspondingly, a defect in the concrete tensioning element causes a change in the measured signal. This is known in itself, wherein the alternating field signal generated by any existing metal cylinder and the directly measured alternating field signal are in principle significantly larger than the actual signal of interest based on the concrete tensioning element. Correspondingly, with the setups known from the prior art, it has not been possible to date to measure the signal based on a fracture in the concrete tensioning element with sufficient accuracy compared to the much larger signal based on the alternating magnetic field acting directly from the generator towards the magnetic field sensor and a field induced in any metal cylinder that may be present. The generation of a second, opposing magnetic field should at least substantially lead to compensation of the opposing alternating fields or the alternating fields induced based on the generated alternating fields. This applies in the case of an intact concrete tensioning wire, which can be used in the same way as the metal cylinder or similarly acting metallic parts of a concrete pipeline to generate, for example, circumferentially directed currents.

If the pipeline being inspected is intact, the signals generated largely cancel each other out. However, if the structure is no longer intact due to a fracture in the concrete tensioning element, the signal is no longer completely canceled out when two opposing alternating fields generated by the excitation units are used when driving over the place of fracture or driving along the place of fracture, and a characteristic signal is generated. This stands out clearly from the other measured signals and varies depending on the position in relation to the place of fracture. As the significantly stronger signals are still substantially compensated for at the same time, such a method has a high sensitivity for the desired signal.

The sensor signal contains three components according to the present consideration. A first component S_{d}(t) results from the alternating magnetic fields generated directly by the excitation units. Another component Sₑ(t) results from eddy currents induced in the cylindrical metal of the pipeline. In addition, a component Sₛ(t) results from the currents induced in the concrete tensioning element:

$${S}_{Sensor} ( t ) = {S}_{d} ( t ) + {S}_{e} ( t ) + {S}_{s} ( t )$$

The individual signal components result from different physical effects. The amplitudes and phase values in relation to the phase of the alternating magnetic field generated by the excitation units vary for S_{d}(t) and Sₑ(t) depending on the distance of the sensor from the excitation unit and the excitation frequency of the generated magnetic field. The phase of Sₛ(t), on the other hand, depends in particular on the thickness of the metallic layer and the excitation frequency, while the amplitude of Sₛ(t) also varies with the excitation frequency and the distance between the magnetic field sensor and the excitation unit. The phase and amplitude of Sₛ(t) depend much more strongly on the excitation frequency than Sₑ(t). If there is no metal cylinder, Sₑ(t) is zero.

Assuming that S_{d}(t)+Sₑ(t) does not change due to a defective wire, these can be summarized as Sᵢ(t):

$${S}_{s} ( t ) = {S}_{i} ( t ) + {S}_{s} ( t ) = {A}_{i} {e}^{i ( {θ}_{i} + ω t )} + {A}_{s} {e}^{i ( {θ}_{s} + ω t )}$$

The different dependencies on the excitation frequency and the distance of the magnetic field sensor to the excitation unit allow the phase to be adjusted by the measurement setup and the frequency to be selected specifically for the pipe wall. In particular, the optimum setup must be determined for each pipeline in combination with the design of the excitation units, in particular those with coils, their excitation frequency and the distance between the excitation units and the magnetic field sensor(s) by means of calibration. For this purpose, prior to a series of measurements, one can conduct own tests or use a database with calibration data.

Sₛ is easy to determine if Sₛ(t) is orthogonal to Sᵢ(t). In addition, if a metal cylinder is present, S_{d}(t) and Sₑ(t) should run in opposite directions if possible, although good measurement results can already be achieved at angles of around 50°.

It also follows from the above geometric relationship that the dependence of the phase change on the amplitude contribution Aₛ increases with decreasing Aᵢ. By using two excitation units that generate opposing alternating magnetic fields, Aᵢ is now reduced. Depending on the setup, the implementation of the method according to the invention or the use of a setup according to the invention results in sensitivity improvements in the measurement by a factor of 10 to 40 compared to the prior art, wherein it is taken into account that the use of two excitation units results in further advantages in the detection of the defect. As will be explained below, the use of two coils gives the defect signal a special shape that makes it much easier to detect.

Compared to the prior art, the method according to the invention and the structure of an inspection device described below allow a significant shortening of the measurement setup by at least a factor of two in some cases. At the same time, the method is much more sensitive in terms of detecting places of fracture. Since shorter distances between the excitation units can be used, the sensor not only has a better resolution, but an associated device is also much more suitable for use in pipelines.

The generated magnetic fields are opposed to each other if the associated excitation units are designed such that the vectors of the magnetic field strength or flux density describing the alternating magnetic fields are opposed to each other or at least approximately opposed to each other (angular deviation in particular <30°, preferably less than 10°, from a direct alignment in the opposite direction). In particular, the alternating magnetic fields (also known as ‘magnetic fields’) are generated in the axial direction and exactly opposite to each other.

With regard to the generation of the opposing magnetic fields by the excitation units, these should ideally differ in phase by 180°. Deviations of no more than 20° are also still suitable to allow the defects of the concrete tensioning element.

Coils are used in particular to generate the alternating electromagnetic fields, these are preferably arranged axially, i.e., in the longitudinal direction of an inspection device with windings arranged symmetrically around its longitudinal axis or longitudinal central axis. The coil axis then lies in particular in the longitudinal central axis of the inspection device. Hall sensors or GMR sensors can in particular be used as magnetic field sensors. If the magnetic field sensor has a coil, its coil axis is preferably parallel and in particular congruent with the longitudinal central axis.

An inspection device according to the invention for inspecting a metallic concrete tensioning element of in particular a water-carrying pipeline, has at least one first excitation unit, preferably comprising a first excitation coil, for generating a first alternating magnetic field and at least one second excitation unit, preferably comprising a second excitation coil, spaced apart from the first excitation unit, for generating a second alternating magnetic field, wherein the excitation units are designed and controllable such that the first and second magnetic fields have opposite directions. In particular, the excitation units are spaced apart in the longitudinal direction of the inspection device, which during operation corresponds approximately to a longitudinal axis of the pipeline to be inspected. Furthermore, the inspection device according to the invention has at least one magnetic field sensor arranged between the first and the second excitation unit for recording a resulting magnetic field. It goes without saying that such an inspection device, which is designed to work with pipelines, has corresponding electrical or electronic components for this purpose. The magnetic field sensor is also connected to this electronic device for recording data. In addition, the inspection device according to the invention is equipped with further conventional means for autonomous travel in a pipeline, which may include energy storage means, data storage means and in particular means for determining the position of the device in a pipeline.

The device is embodied in particular as an autonomous inspection device in such a way that it can travel through a pipeline without a cable connection for energy and/or data communication and thus without being bound. It is designed for use in a method according to the invention described above or below.

Advantageously, the excitation units generate magnetic fields whose amplitudes differ by no more than 10%, preferably by no more than 5%. Amplitudes that are as equal as possible ideally cancel each other out. According to the invention, it can therefore be advantageous if the generated magnetic fields differ slightly by no more than 10% and preferably by no more than 5%, but do not have equal amplitudes. This is based on the finding that the smaller the difference between the resulting magnetic fields generated by the two excitation units, the better the disturbance caused by a defect in the concrete tensioning element can be measured, but at the same time the phase signal becomes undefined if the values are too small. Therefore, for stable phase determination of the measurement signal, a small difference between 0 and up to 10% or up to 5% with respect to the amplitude of the generated alternating magnetic fields can be advantageous and should be set.

In general, the frequency and distance can be selected specifically for each pipe using a corresponding calibration database.

Preferably, the alternating magnetic fields provided with opposite directions are essentially axially aligned, i.e., generated in the axial direction, for example, by windings of a coil extending around a longitudinal central axis of the inspection device, which can also have a magnetic core along or accommodating the longitudinal central axis. Such a setup is advantageous for in particular spirally arranged concrete tensioning elements, which can be regarded as a structure extending in the axial direction, since the coils can be built sufficiently large and in particular can have a diameter of up to 75% of the diameter of the pipeline under consideration.

During an inspection or measurement run with an inspection device, the measurement data recorded by the magnetic field sensor is either stored directly in the inspection device, for example, in the form of a pig, and further processed there. Alternatively, the data can also be read out from the inspection device after completion of a measurement run or a measurement cycle and evaluated in a conventional EDP device. Such an electronic data processing device has, among other things, the usual means such as processor, transient and permanent memory, input and output interfaces, and means for controlling the program sequences for evaluating the data. The EDP device is designed to evaluate the measurement data with regard to amplitude and phase. The EDP device can also be part of the inspection device so that the detected defects and, if necessary, the associated raw data can already be read out. Furthermore, the inspection device can have means for determining the position and orientation of the inspection device. The location and position data from gyroscopes or an odometer, for example, can be linked to the measurement data from the magnetic field sensor to identify the position of a defect.

Advantageously, a defect in the concrete tensioning element is detected in an evaluation based on two successive, in particular different, extrema of the amplitude and/or phase of the resulting field. Such an oscillation-like signal shape allows easier detection of the fracture in the presence of noise and is also easier to detect in the measurement data than the signals generated in the prior art. For example, such oscillation-like signals can be detected via a wavelet analysis based on the Haar wavelet. A wavelet analysis makes it possible to take into account a possible elongation of the signal shape, for example, due to several successive disturbances or fractures of the concrete tensioning element.

In particular, the received data are thus analyzed for wavelets which arise when the inspection device passes the place of fracture of the concrete tensioning element, wherein a wavelet is usually regarded as a wave-like oscillation of a signal, i.e., the occurrence of a minimum with a direct transition to a maximum or vice versa. When considering the real and imaginary parts of the measurement signal, regardless of any background noise, this is a movement around the zero point.

Advantageously, the measurement data is recorded by the magnetic field sensor centrally between the excitation units, wherein centrally means, for example, in a side view of the excitation units and the distance then recognizable due to a spacing of the excitation units in the longitudinal direction of the inspection device. This location provides the optimum conditions for detecting a measurement signal generated by a disturbance. However, when considering certain phase differences, it can make sense to place the magnetic field sensor off-center between the excitation units. A central arrangement refers to an arrangement in a central area between the excitation units and in particular an arrangement that encompasses the exact center between the excitation units. Magnetic parts of the inspection device and/or manufacturing inaccuracies can amplify or weaken one of the excitation units, resulting in an uneven winding of the excitation unit. This imbalance can be at least partially corrected by shifting the sensor position of the magnetic field sensor in the longitudinal direction.

The inspection device moves independently through the pipeline while recording the measurement data. Due to the fact that it is not tied to a cable, large distances can be covered. Since, with a corresponding setup of the inspection device according to the invention, the energy consumption can also be optimized due to the significantly better detectable signal than in the prior art, even large distances of more than one kilometer of pipeline can be inspected without restriction.

The movement of the inspection device is in particular passive due to the flow present in the pipeline, in particular the water. Alternatively, it can also be an inspection device that actively moves through the pipeline using its own drive means. Combinations of actively and passively driven inspection devices are also conceivable, which initially only perform an initial rough inspection and then, when relevant signals are detected, switch from the passive mode to an active mode in order to return to the location against the flow of the current to inspect the detected location more closely.

The excitation units are arranged one behind the other in the longitudinal direction of the inspection device and in particular symmetrically around the longitudinal central axis, wherein an alternating magnetic field is generated over the entire circumference. They can be controlled in parallel via the same electronics or each have their own machine control units that are synchronized with each other.

Furthermore, according to the invention, the finding is used that, depending on the frequency for generating the first and second alternating magnetic fields and the distance between the two excitation units, at the location of the measurement data acquisition a phase difference can be caused between the signal determined from the direct signal, the signal component of any cylinder present, and the signal component generated by the at least one concrete tensioning element. By selecting the frequency appropriately, the phase and/or amplitude of the measurement signal is influenced mainly by the signal resulting from the concrete tensioning element.

Thus, measurements at different frequencies have a different sensitivity for different structural elements in the pipeline wall. Since the measurement can be performed simultaneously at different frequencies, it is advantageous in a further embodiment of the invention to use more than two frequencies for the measurement. A pulse with a broader frequency spectrum can then be used as the excitation signal.

When measurements are made with at least two different excitation frequencies, the resulting signal can be cleaned up, in particular from structural influences of the pipeline. If signal changes occur simultaneously at different frequencies, one of which is more sensitive to fractures than the other, this is an indication of structural changes in the pipeline. This means that pipelines with metal cylinders with a wall thickness of 2 mm can be measured at frequencies of 20 Hz and 200 Hz, wherein fractures of the concrete tensioning element due to the skin effect in the metal cylinder can substantially only be detected at 20 Hz. If, however, changes in the signal occur simultaneously at both 20 Hz and 200 Hz, this indicates a structural change in the pipeline that is not due to a fracture in the concrete tensioning element.

Furthermore, when using different frequencies, any structural changes can be identified based on their characteristic signals in the resulting magnetic field. The signal shapes thus found in this way can be stored in a database for improved detection of corresponding structural changes or structures and used for future structure detection.

In particular, coils wound symmetrically around the longitudinal central axis are used as excitation units. In pipes with metal cylinders, these coils are preferably in a range of 10 to 800 Hz and can thus be operated at low frequencies. At 800 Hz, the maximum wall thickness is 1 mm. In particular, for pipelines with a metal cylinder wall thickness of more than 2 mm, a frequency of less than 200 Hz is used.

In pipelines without metal cylinders, the alternating magnetic fields are preferably generated at frequencies greater than 100 Hz, preferably greater than 1000 Hz. An upper limit for the excitation frequency is 1000 kHz in particular.

In particular, the excitation of the alternating magnetic fields is continuous, both when using one frequency and when using several frequencies. When using higher frequencies above 1 kHz, the alternating magnetic fields can be excited with frequency bursts so that sufficient information on the resulting magnetic field can be collected even with short measurements.

Preferably, if several frequencies are used, these can be generated simultaneously and/or one after the other.

In data evaluation, in particular when using several frequencies, a lock-in amplifier is preferably used on the electronics side in order to evaluate the frequency-specific signals of the resulting magnetic field.

In particular, the frequencies of the alternating magnetic fields for pipelines with metal cylinders with a wall thickness of 2 mm are in the range of 20 to 50 Hz. If at least one additional frequency is used, this additional frequency is preferably between 100 Hz and 800 Hz. Due to the alternating magnetic fields generated in the axial direction, the resulting magnetic field is in particular not sensitive to lift-off of a magnetic field sensor from a wall of the pipeline. Therefore, the resulting magnetic field is measured in particular in the center of the pipeline, wherein a magnetic field sensor can be constructed that is sufficiently large and significantly larger than in the prior art. A measurement in the center of the pipeline corresponds to an arrangement of a magnetic field sensor, for example, in the form of a coil, symmetrically around a longitudinal central axis of the inspection device.

The axial arrangement of the sensor allows the use of a significantly larger sensor design. Correspondingly, the diameter of the sensor or sensor coil can be significantly increased. This enables the compensation of fluctuations due to inhomogeneities in the pipeline wall or significantly reduces these disturbing influences as well as any velocity-related interference components of the measurement signal. If necessary, however, the resulting magnetic field can be measured alternatively or in particular additionally with a further sensor arranged outside the center of the pipeline. This can be positioned close to the wall to obtain additional information about the integrity of the pipeline. In addition, axial and radial components can be measured. The recording of two or three components of the resulting magnetic field can provide combined information about the integrity of the pipeline.

According to a further advantageous design of the method according to the invention, the resulting magnetic field is detected by a plurality of magnetic field sensors which are arranged one behind the other in the longitudinal direction of the inspection device and in particular axially on the inspection device, and consequently at a plurality of positions located one behind the other. This enables not only the amplitude and phase of the magnetic field to be measured, but also its variation along the pipeline axis. The data used can, for example, be used to determine initial or multiple derivatives of the amplitude function and phase function. The combined evaluation of the detected features for the amplitude function and phase function and their variation along the longitudinal axis makes it possible to reduce the number of possible misidentifications due to inhomogeneities in the pipeline.

Advantageously, in the case of a plurality of sensors arranged one behind the other, preferably axially, those data of the magnetic field sensor can be evaluated in which the at least approximate balance between the alternating fields generated by the excitation units is best suited for the evaluation. Since the balance between the excitation units or the alternating magnetic fields generated by them can change due to a variety of influences of the pipeline or the inspection apparatus or the inspection device, it can be advantageous to switch to a sensor and its data other than the one located exactly centrally between the excitation units. In particular, however, the magnetic field sensor or sensors is/are arranged in an area centrally between the excitation units, which corresponds to 50% of the distance between the excitation units. Correspondingly, the measurement data is recorded in this area in particular.

The magnetic field sensor or sensors of an inspection device according to the invention are thus arranged between the sensors spaced apart from each other in the longitudinal direction, wherein in particular the inspection device is designed to move in a pipeline of a diameter D and the distance between the excitation units is <2*D and in particular <1.5*D. Another advantageous feature is that the distance is <2*diameter_{Cup/Disk} and in particular <1.5*diameter_{Cup/Disk}, in particular in the case of inspection devices that are driven passively via corresponding cups or disks.

While in devices according to the invention as described above, the magnetic field sensor can be arranged centrally when viewed in the longitudinal direction and correspondingly accommodating a central longitudinal central axis of the inspection device, magnetic field sensors can additionally be arranged offset in the longitudinal direction and/or in the radial direction between the excitation units.

In particular, it is advantageous to use a plurality of sensors arranged radially offset from each other for measuring the resulting magnetic field, based on the finding that, depending on the structure of the pipeline wall, the position of a place of fracture of the concrete tensioning element in the circumferential direction can influence the axial symmetry of the magnetic field. For example, in a case where the concrete tensioning element is wound in the form of a wire spirally around the metallic, cylindrical core of the pipeline, with a distance of several cm between the windings and the associated continuous reductions in the currents occurring, asymmetrical components of the magnetic field occur in the vicinity of the defect. The occurrence and change of such asymmetric components can be detected by correspondingly radially offset sensors.

In a further embodiment according to the invention, it is advantageous when the alternating fields generated by the excitation units are attenuated in the direction of the at least one magnetic field sensor via two shielding elements. The shielding elements are in particular disc-shaped and arranged one in front of and one behind the magnetic field sensor(s) in the direction of the respective excitation unit. The shielding element is in particular made of a conductive or respectively magnetic material. By using such shielding elements, the sensitivity of the measurement data can be increased and, in addition, the distance between the excitation units can be reduced correspondingly, which in turn improves the resolution of the measurements. However, it should also be noted that the shielding elements can impair the device's ability to pass through pipelines due to their weight and the comparatively large diameter required. In this respect, flexible shielding elements for improving the ability to bend, for example, in the form of shield-like extendable or retractable shielding elements, are advantageous.

According to a further embodiment of the method according to the invention, alternating magnetic fields of different frequencies are generated successively and/or simultaneously and the resulting measurement data are recorded by the at least one magnetic field sensor. This is based on the finding that the balance between the alternating magnetic fields generated can be disturbed, for example, by movement of the inspection device or by changes in the pipeline wall. Such disturbances of the balance result in changes in the amplitude and phase of the signal in the measurement data, which can correspondingly be misinterpreted as a fracture signal of the concrete tensioning element. Such misinterpretations can be detected by measuring at different excitation frequencies and excluded internally. Changes due to fractures in the concrete tensioning element are clearly different in their signal shape at different frequencies than changes due, for example, to disturbances in the balance caused by tool movement or the wall structure.

Measurements at different frequencies result in different fault signals at the same fault location. This gives a defect a specific pattern that is composed of signals at different frequencies and thus differs from noise. Within the scope of the invention, it was found that a combined measurement at different frequencies not only enables better detection of the fault, but also better estimation of the number of fractures.

When using different frequencies, a main frequency can be selected as the frequency which, based on any calibration data, results in the strongest interference signal in the event of a fracture in the concrete tensioning element, for example, which results in the strongest phase change. A further frequency can then be selected that is lower than the main frequency, for example, a frequency at which there is mainly an amplitude difference in the measurement signal.

In order to identify other structural changes other than a fracture in the concrete tensioning element, at least one second frequency greater than the main frequency can be selected as described above in order to amplify skin effects of any metal cylinder present and thus rule out interaction with the concrete tensioning element.

For generating different frequencies, the same excitation units or respectively a plurality of pairs of excitation units operating at different frequencies can be used on the same inspection device. Of course, it is also possible to combine inspection runs that have taken place consecutively at different frequencies.

Advantageously, in the data evaluation, an interference signal is reduced by subtracting the scaled amplitude values from the phase values. For this purpose, corresponding optimal scaling factors for the amplitude signal as well as any parameters of the measuring system such as the excitation frequency can be determined during a calibration process. This is again based on the finding that the interference signal resulting from a fracture in the concrete tensioning element is reflected differently in amplitude and phase.

In order to determine the position of the place of fracture in the circumferential direction, it is advantageous to arrange a plurality of magnetic sensors around a longitudinal central axis. For example, a setup is advantageous in which, in addition to a single sensor that is configured symmetrically to the longitudinal central axis, for example, to accommodate it, a plurality of two, three, four or more sensors are also arranged evenly distributed around the circumference. The sensors distributed around the longitudinal central axis in the circumferential direction can also partially intersect it or, can at least partially overlap each other at least when viewed in the longitudinal direction.

The use of an inspection device in which the distance between the excitation units can be variably adjusted is particularly advantageous. This allows the inspection device to be adapted to different pipelines. The adaptability results, for example, from an exchangeable central body, from exchangeable modules of the central body on which the sensors are or can be fastened, or also from a corresponding fastening system, for example, based on a thread or a plug-in system, via which the distance between the excitation units can be adjusted in the longitudinal direction.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows a subject matter according to the invention in a perspective view.

FIG. 2 shows the subject matter according to FIG. 1 in a side view.

FIG. 3 shows the subject matter according to FIG. 1 in an operating position in a water-carrying pipeline.

FIG. 4 shows an illustration of signal generation.

FIG. 5 shows a view of the portions of the measurement data in the event of an existing defect in the concrete tensioning element.

FIG. 6 shows an illustration of a sensor setup with resolution of the position in the circumferential direction.

FIG. 7 shows a further illustration of the sensor setup for a resolution in the circumferential direction.

FIG. 8 shows an illustration of the phase values at different frequencies, phases, and amplitude data in the area of a defect and in the presence of interference.

FIG. 9 shows an illustration of phase and amplitude functions near a defect and in the presence of significant interference.

FIG. 10 shows a further embodiment according to the invention.

FIG. 11 shows the subject matter according to FIG. 10 in a vertical longitudinal section.

FIGS. 12 to 14 show different measurement results for a plurality of tests.

### DETAILED DESCRIPTION OF THE DRAWINGS

Individual technical features of the embodiments described below can also be combined with embodiments described above as well as the features of one of the independent claims and any further claims to form subject matters according to the invention. Where appropriate, identical reference numbers are assigned to elements that have at least partially the same function.

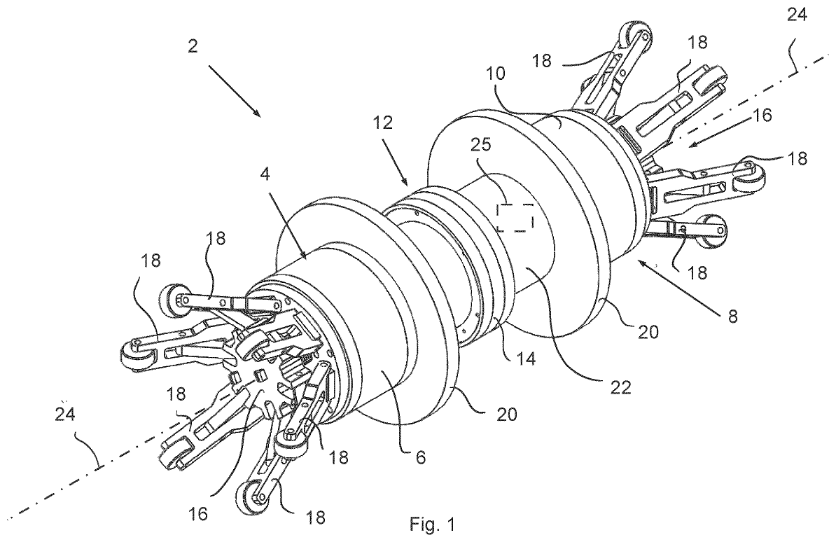

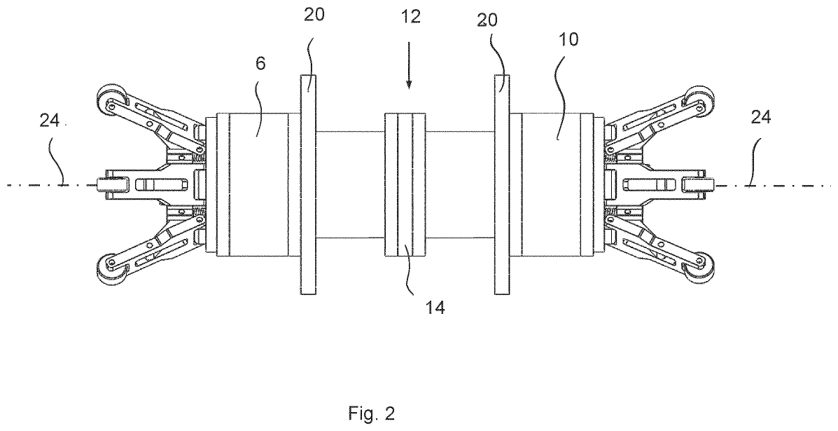

An inspection device 2 according to the invention has a first excitation unit 4 with a first excitation unit 4 formed concentrically to the longitudinal central axis 24 with a first excitation coil 6 extending symmetrically about a longitudinal central axis of the inspection device 2. A second excitation unit 8 is arranged offset in the longitudinal direction of the inspection device and has a second excitation coil 10, which is also arranged symmetrically around the longitudinal central axis 24 of the device 2 (FIG. 1). The two excitation units 4, 8 are controlled and operated via electronics located in the central body 22 of the inspection device 2, which electronics are indicated by a dashed box 25. The excitation coils 6, 10 generate opposing alternating magnetic fields in the axial direction, i.e., in the direction of the longitudinal central axis 24. Centrally located between the excitation units 4, 8 there is a magnetic field sensor 12 with a coil 14 which also runs symmetrically around the longitudinal central axis 24 and whose diameter, viewed in the direction of the longitudinal central axis 24, is 75% to 100% of the diameter of the excitation coils 6 and 10. Shielding elements 20 are arranged close to the excitation units 4, 8. As in other embodiments, these can generally be placed directly on the respective excitation unit so that any inductive field resulting from an influence on the shielding elements is attenuated as much as possible due to the distance then existing to the magnetic field sensor.

The inspection device 2 is in this case equipped with a series of centering elements 18 in the form of spring-loaded arms provided with rollers at their ends, which center the device 2 as far as possible in the middle of the pipeline as it travels through the pipeline. The inspection device 2 can be coupled to further functional assemblies of an inspection pig via connection areas 16 and, for example, be pulled by the pig through a pipeline. Alternatively, the inspection device itself can also be designed as a pig with corresponding cups or disks for passive propulsion in a pipeline.

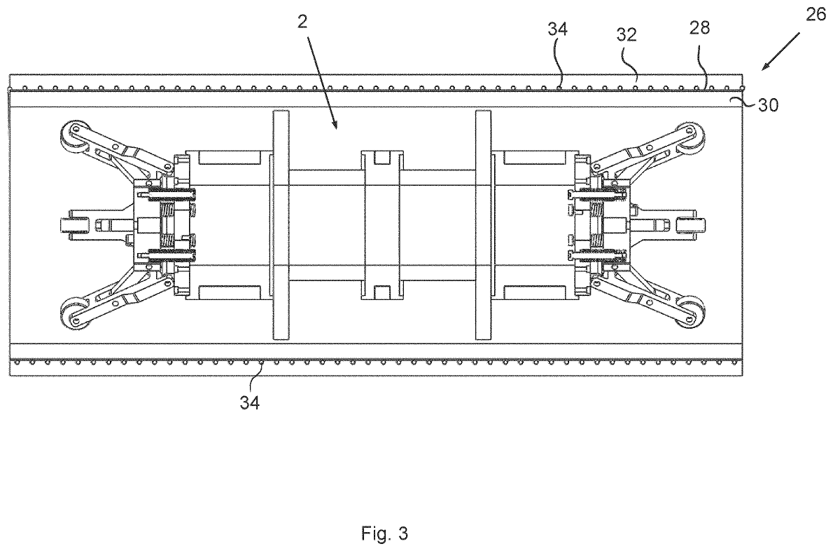

The water-carrying pipeline 26 (FIG. 3) to be inspected has an interior space which is almost completely filled by the inspection device 2 in the longitudinal direction, i.e., in the direction of the longitudinal central axis 24. The pipeline 26 comprises a metallic, cylindrical layer in the form of a metal cylinder 28, which is covered on the inside by an inner concrete layer 30 and on the outside by an outer concrete layer 32. In the outer concrete layer 32, there is a concrete tensioning element 34 in the form of a concrete tensioning wire, which is guided spirally around the longitudinal axis of the pipe, which ideally corresponds to the longitudinal central axis of the inspection device 2. This concrete tensioning wire is arranged close to the cylindrical metal layer 28 but does not touch it. Nevertheless, due to the small distance between the metal cylinder 28 and the concrete tensioning element 34, a sufficient current flow is possible for the measurement. In addition, there can also be connection points for the concrete tensioning wire at the ends of the respective pipeline segment of the pipeline 26.

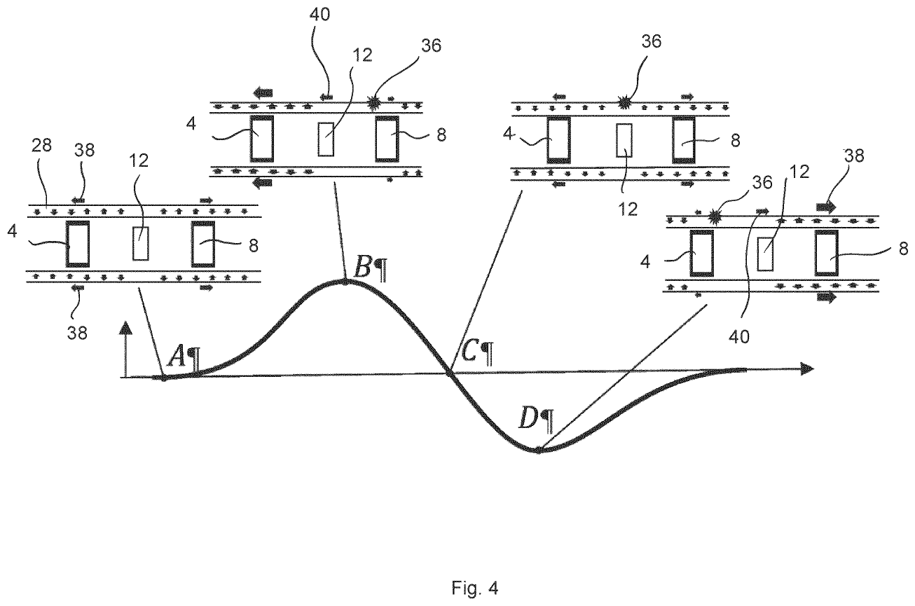

Depending on the position of the inspection device 2 in the pipeline 26, the presence of a defect 36 when passing through the pipeline results in a characteristic signal with two successive extrema, as shown in FIG. 4. Four different positions A, B, C, and D of the defect signal are considered below, to which respective positions of the inspection device 2, which is only schematically shown with the excitation units 4 and 8 and a magnetic field sensor 12, are assigned.

At point A, a balance exists in pipeline 26 at the location of the magnetic field sensor and no relevant signal is measured. The induced current flows along the concrete tensioning element and partially passes into layer 28. The current flowing through the metal layer 28 formed by the metal cylinder closes the circuit through the concrete tensioning element and precisely this layer 28. The arrows 38 and 40 outside layer 28 indicate the direction of propagation of the current through the concrete tensioning element. The spiral shape of the concrete tensioning element ensures that the current flow spreads along the pipe from one turn of the spiral to the next. The current flow induces a magnetic field which is detected by the magnetic sensor. The opposing alternating magnetic fields compensate for the effects at the location of the magnetic field sensor.

Due to a defect 36, no current flow is possible in this area and thus no or a different electromagnetic signal is generated, so that the magnetic fields generated by the currents in the concrete tensioning element do not compensate at the level of the magnetic field sensor, consequently at its longitudinal position. This imbalance in the resulting magnetic field, indicated primarily by a current 40, is measured at the location of the magnetic field sensor. This results in a positive extremum characterized by point B.

This signal weakens again as it travels through the pipeline. When the defect is at the same height as the magnetic field sensor 12, symmetry is again established and a zero crossing occurs at point C.

Further movement of the tool in the pipeline, in this case in the direction of the right-hand edge of the figure, results in an opposite signal, since defect 36 now interferes with the propagation of the current in the concrete tensioning element in the area of excitation unit 4. Due to the imbalance also indicated by arrow 40, there is a local minimum in the evaluated measurement data at point D.

A further movement of the inspection device 2 in the direction of the right-hand edge of the figure then leads again to the establishment of balance, which is illustrated by a corresponding curve starting from point D and now again approaching the zero point.

In general, the alternating magnetic field at the sensor position can be described by a complex vector, which can be described with an amplitude A_{d} and a phase θ_{d} as

$${S}_{d} = {A}_{d} {e}^{i ( ω t + {θ}_{d} )}$$

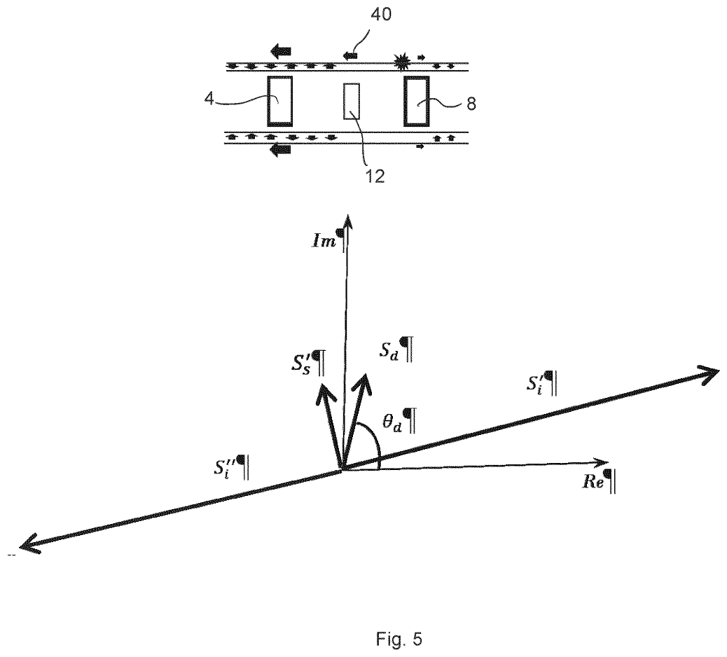

The signal resulting from the defect 36 and the other resulting signals due to the two generated and opposing magnetic fields differ in amplitude and phase (FIG. 5). S′ and S″ denote the signals induced by the first excitation unit 4 and by the second excitation unit 8. The index ‘i’ quantifies the sum of the alternating fields that are insensitive to the defect, induced and opposed to each other. The index ‘s’ indicates the signal components that are measured at the sensor location due to the interaction of the generated alternating magnetic fields with the concrete tensioning element. In the present case (FIG. 5), the proportion

$${S}_{i}^{′′}$$

is negligible and correspondingly not shown, since the defect prevents the propagation of the current through the concrete tensioning element. Furthermore,

$${S}_{i}^{′′}$$

is slightly smaller than

$${S}_{i}^{′} ,$$

which is advantageous for the phase relationship. At the same time, the excitation frequency is selected so that the phase difference between the vectors Sᵢ and Sₛ is close to 90°. According to the present configuration, the component Sᵢ^{′} is not compensated, so that a corresponding defect or an associated phase angle can be easily derived from the measurement data.

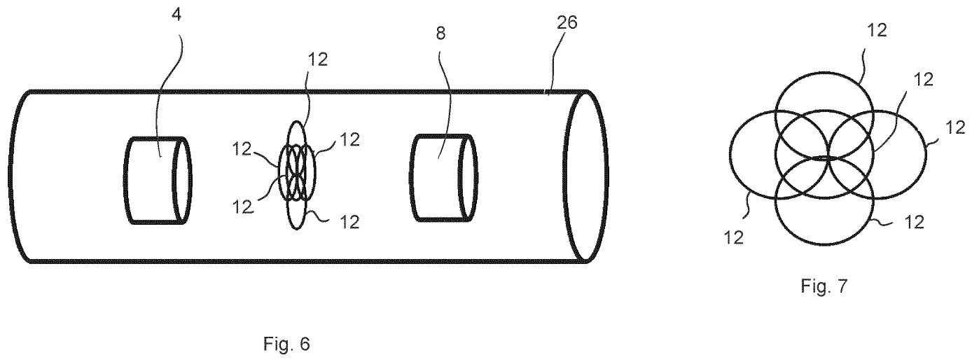

A possible sensor setup of the magnetic field sensors for determining the circumferential position of a defect is shown schematically in FIG. 6. Here, a plurality of five magnetic field sensors 12 are located between the excitation units 4 and 8. The outer circumference of the respective coils of the magnetic field sensors 12, which are shown schematically in FIG. 7 viewed in the longitudinal direction, is illustrated. The middle coil is used to determine the defect position in the axial direction, i.e., in the direction of the longitudinal central axis. Analysis of the relative signal changes in the four additional coils or magnetic field sensors 12 enables the position to be determined in the circumferential direction. For example, a comparison of the signals between the upper and lower magnetic field sensors 12 can be used to limit the position of the defect to the upper or lower half of the pipeline.

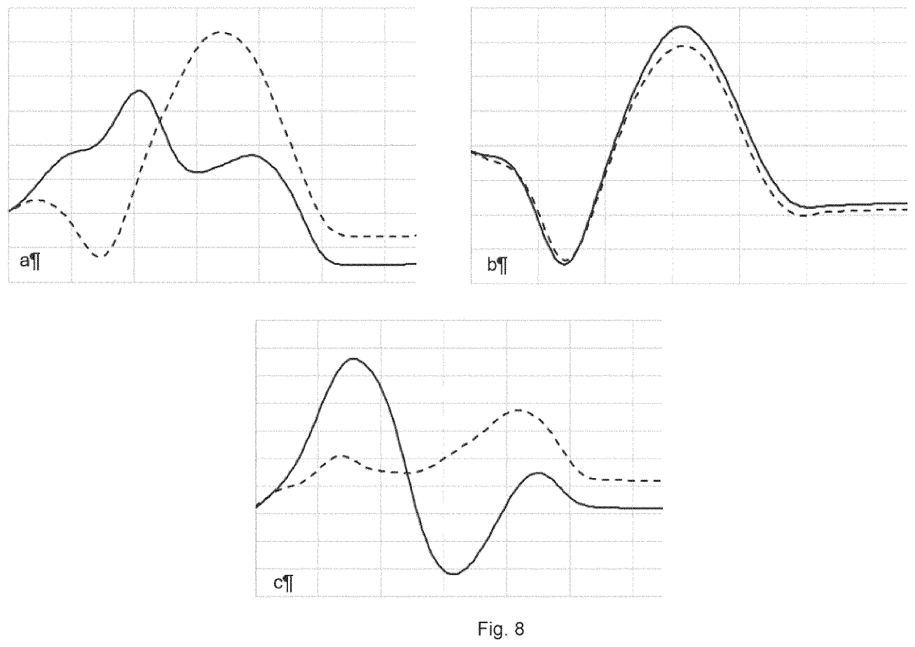

FIG. 8 illustrates the different phase values of the measurement signal resulting from the resulting magnetic field at different excitation frequencies and in the presence of a strong interference signal. The solid lines in FIGS. 8a, 8b, and 8c show the signal when a concrete tensioning element in the test setup is defective. The dashed lines show the phase values for an intact concrete tensioning element. In FIG. 8a, the alternating magnetic fields were determined at a frequency of 50 Hz, and in FIG. 8b at a frequency of 200 Hz. FIG. 8c shows the differences between the measured values at 50 Hz and 200 Hz. The effects of the defect in the measurements at 200 Hz are negligible, in particular due to the skin effect, wherein the measurements at 50 and 200 Hz for an intact wire produce comparatively similar signals. By subtracting the signals measured at different frequencies, the interference signal can be greatly reduced. Correspondingly, the signal curve characteristic of a defect can be clearly recognized, initially with a local extremum (in this case positive) and a transition to a local extremum of a negative type.

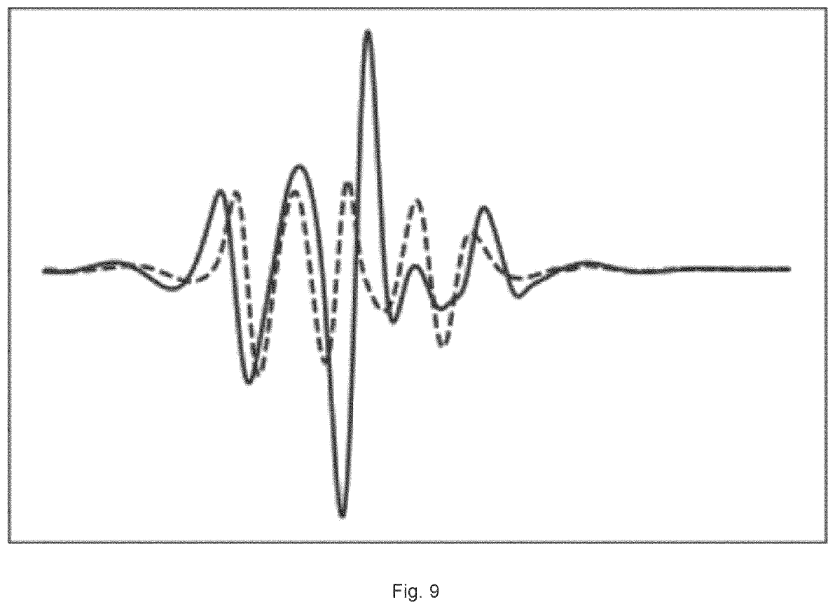

FIG. 9 shows examples of phase-amplitude functions near a defect and in the presence of significant interference. The solid curve shows the phase values and the dashed curve shows the amplitude values. The curves again apply to a setup of a pipeline with a diameter of 440 mm. The increase in the phase value in the middle of the recorded signal corresponds to the defect. The amplitude function is scaled, wherein the scaling coefficient was selected such that after scaling to the intact pipeline sections the amplitudes of the phase-amplitude functions are equal or at least similar. Outside the defect area, the amplitude and phase function correlate with each other, so that a scaling coefficient can be obtained from this. This correlation can be used to reduce the influence of interference, wherein the correlation can vary, for example, depending on the pipeline wall, the excitation frequency, and the distance between the excitation coils.

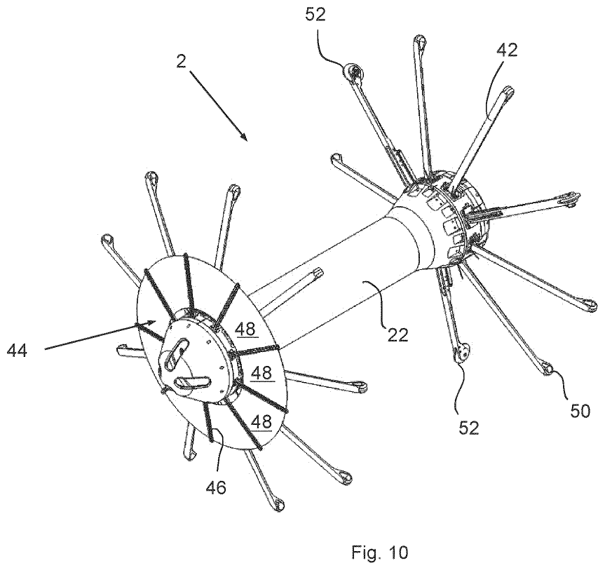

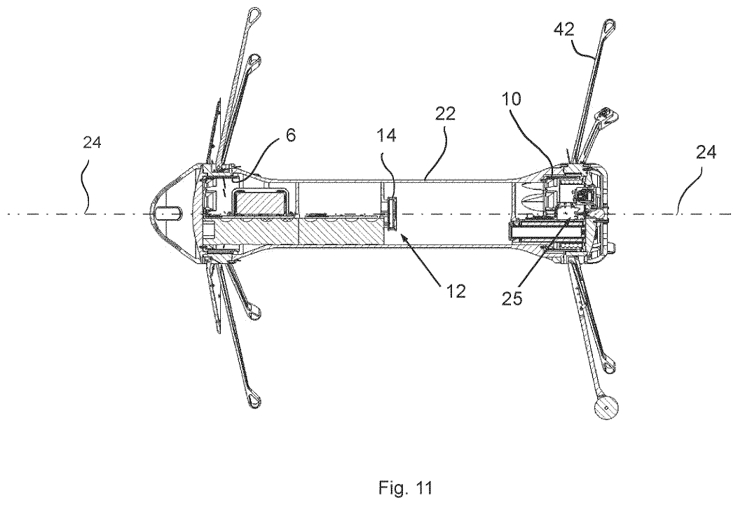

Another embodiment of an inspection device according to the invention is in particular suitable for pipelines equipped with butterfly valves and carrying water or other media, wherein the inspection device 2 has a central body 22 which has a plurality of support elements 42 arranged in an articulated and/or fixed manner on the central body 22 (FIG. 10). If the support elements 42 are not arranged in an articulated manner or do not have bendable sections, the support elements 42 are at least sufficiently flexible in design so that, upon hitting a butterfly valve, the effective cross section of the inspection device 2 is reduced to less than half the pipe diameter.

A propulsion element 44 is arranged at the front end of the inspection device 2 in the direction of travel, which is clamped in the medium and causes propulsion and entrainment of the device due to the pressure exerted by the medium. This propulsion element 44 also has a plurality of segments 48 spanned by tension rods 46, which segments can also be bent due to the articulated arrangement of the tension rods 46 on the central body 22, whereby the effective cross section of the inspection device 2 (viewed in the longitudinal direction thereof) is also reduced correspondingly.

At the ends of the support elements, there can be respective roundings 50 which touch the inside of the pipeline to be inspected as gently as possible. In addition, odometer 52 can be arranged at the end of the individual support elements 42 in order to better determine the position of the inspection device 2 in the pipeline.

Within the central body 22, which can be structured in a modular manner with a plurality of sections, a first excitation coil 6 of a first excitation unit 4 is arranged, wound centrally around the longitudinal axis 24. This excitation unit is located in relation to the longitudinal axis or longitudinal central axis 24 at the height of the front support elements. A further, second excitation coil 10 is arranged at the rear end of the inspection device 2, approximately at the level of the rear support elements 42.

An outer wall 54 of the central body 22 is preferably made of a non-magnetizable material, in particular a plastic composite material.

A sensor coil 14 of a magnetic field sensor 12 is arranged centrally between the two excitation coils 6 and 10, again symmetrically around the longitudinal axis 24. This records measurement data based on the resulting magnetic field, which is evaluated in terms of magnitude and/or phase.

In a plurality of tests, the sensor setup described in the following table was tested in a pipeline for water with a diameter D=440 mm, which has a metal cylinder with a wall thickness of 2 mm coated with concrete on the inside and outside. In the outer concrete layer, a spirally wound concrete tensioning wire is arranged around the metal cylinder at a distance of a few millimeters. In addition to a central magnetic field sensor, two excitation coils were used as excitation units:

| Parameters | Excitation coil | Magnetic field sensor |
|---|---|---|
| Outer diameter | 125 mm | 12 mm |
| Inner diameter | 100 mm | 5 mm |
| Length | 50 mm | 20 mm |
| # of windings | 800 | 200 |

The distance between the excitation units was set to a maximum of 70 cm. For calibration purposes, other distances <2*D were tested. The magnetic field sensor is fixed between the excitation units, but its axial and radial position can be varied.

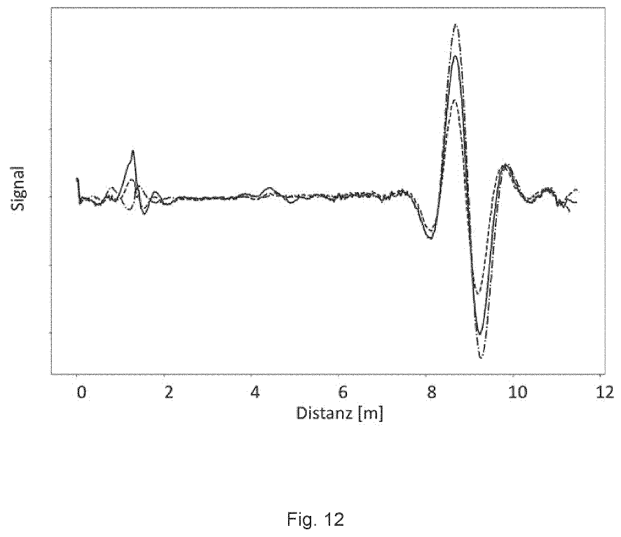

Three test runs were carried out, in each of which the inspection device was passed over an area with a different number of places of fracture in the concrete tensioning element, which in this case was designed as a concrete tensioning wire. The associated measurement results and evaluations are shown in FIGS. 12 to 14. The dashed line in FIGS. 12 to 14 is from a setup with three wire fractures in the concrete tensioning element, the solid line is from a setup with six wire fractures and the dash-dotted line from a setup with nine wire fractures. The wire fractures each come immediately after one another.

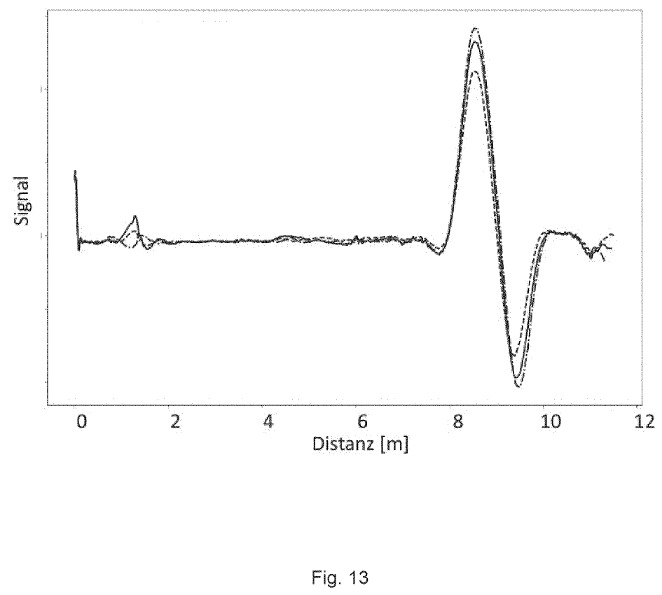

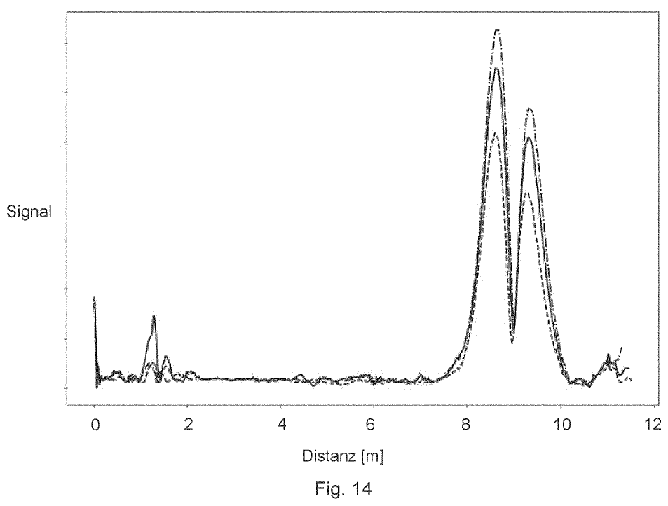

The recorded amplitude of the signal (FIG. 14) shows recognizable extrema in the area of the fractures. FIG. 12 shows the imaginary part of the evaluated signal, which, like the real part of the evaluated signal (FIG. 13), has the form described above with a further extrema following a first extrema. These results independently show characteristic and identical patterns for different numbers of wire fractures, which patterns are easily detectable.

1. A method for inspecting a metallic concrete tensioning element, the method comprising the steps of:
generating, with at least one first excitation unit of an inspection device, a first alternating magnetic field; and
generating, with at least one second excitation unit of the inspection device, a second alternating magnetic field, wherein the second excitation unit is spaced apart from the first excitation unit,
wherein the first and second magnetic fields having opposite directions, and
wherein during a movement of the inspection device along the concrete tensioning element at least at one position between the first and the second excitation units via at least one magnetic field sensor of the inspection device, measurement data are recorded based on the resulting magnetic field, which measurement data are evaluated with regard to the magnitude and/or phase of the resulting magnetic field.

2. The method according to claim 1, wherein the excitation units generate magnetic fields whose amplitudes differ by no more than 10%.

3. The method according to claim 1, wherein the alternating magnetic fields provided with opposite directions are axially aligned.

4. The method according to claim 1, wherein a defect of the concrete tensioning element is detected based on two successive extrema of the amplitude and/or phase of the resulting field.

5. The method according to claim 1, wherein the measurement data from the magnetic field sensor are recorded centrally between the excitation units.

6. The method according to claim 1, wherein the alternating fields are generated simultaneously and/or successively with different frequencies.

7. The method according to claim 1, wherein the excitation units are arranged one behind the other in a longitudinal direction of the inspection device, and an alternating magnetic field is generated over the entire circumference.

8. The method according to claim 1, wherein the resulting magnetic field is measured in the center of the pipeline.

9. The method according to claim 1, wherein the resulting magnetic field is measured with a sensor arranged outside the center of the pipeline.

10. The method according to claim 1, further including a plurality of magnetic field sensors, wherein the resulting magnetic field is recorded via at least some of the magnetic field sensors at a plurality of positions located one behind the other in a longitudinal direction of the inspection device.

11. The method according to claim 10, wherein data of the magnetic field sensor is evaluated in which an at least approximate balance between the alternating fields generated by the excitation units is best suited for evaluation.

12. The method according to claim 1, further including a plurality of magnetic field sensors, wherein the respective resulting magnetic field is measured via at least a plurality of magnetic field sensors arranged offset from one another in the radial direction.

13. The method according to claim 1, wherein via two shielding elements the alternating fields generated by the excitation units are attenuated in the direction of the at least one magnetic field sensor.

14. The method according to claim 1, wherein alternating magnetic fields of different frequencies are generated successively and the resulting measurement data are recorded by the at least one magnetic field sensor.

15. The method according to claim 14, wherein, in the data evaluation, an interference signal is reduced by subtracting the scaled amplitude values from the phase values.

16. An inspection device for inspecting a metallic concrete tensioning element, the inspection device comprising:
at least one first excitation unit for generating a first alternating magnetic field,
at least one second excitation unit, spaced apart from the first excitation unit, for generating a second alternating magnetic field, wherein the excitation units are controllable such that the first and second magnetic fields have opposite directions; and
at least one magnetic field sensor arranged between the first and second excitation units for recording a resulting magnetic field.

17. The inspection device according to claim 16, wherein the inspection device is embodied as an autonomous inspection device.

18. The inspection device according to claim 16, wherein the magnetic field sensor is arranged between the excitation units, which are spaced apart from one another in the longitudinal direction.

19. The inspection device according to claim 16, wherein the inspection device is designed to move in a pipeline of a diameter D and the distance between the excitation units is less than 2*D.

20. The inspection device according to claim 16, wherein the magnetic field sensor is arranged centrally when viewed in the longitudinal direction.

21. The inspection device according to claim 20, further including a plurality of magnetic field sensors, wherein magnetic field sensors are additionally arranged between the excitation units offset in the longitudinal direction and/or in the radial direction.

22. The inspection device according to claim 16, wherein a plurality of magnetic sensors are arranged around a longitudinal central axis.

23. The inspection device according to claim 16, wherein the distance between the excitation units is variably adjustable.

24. The method of claim 1, wherein the at least one first excitation unit includes a first excitation coil; and
wherein the at least one second excitation unit includes a second excitation coil.

25. The method of claim 1, wherein the magnetic field sensor has a sensor coil.

26. The method according to claim 4, wherein the two successive extrema of the amplitude and/or phase of the resulting field are different.

27. The method according to claim 7, wherein the excitation units are arranged symmetrically around the longitudinal central axis.

28. The inspection device according to claim 16 wherein the at least one first excitation unit includes a first excitation coil; and
wherein the at least one second excitation unit includes a second excitation coil.
